(19) United States
(12) Patent Application Publication
(10) Pub. No.: US 2026/0070333 A1
(43) Pub. Date: Mar. 12, 2026

(54) LIQUID EJECTION HEAD, LIQUID EJECTION APPARATUS, AND METHOD OF MANUFACTURING LIQUID EJECTION HEAD

(71) Applicant: CANON KABUSHIKI KAISHA, Tokyo (JP)

(72) Inventors: YOSHIYUKI NAKAGAWA, Kanagawa (JP); TAKASHI KATO, Kanagawa (JP)

(21) Appl. No.: 19/321,964

(22) Filed: Sep. 8, 2025

(30) Foreign Application Priority Data
Sep. 10, 2024 (JP) 2024-156848

(51) Int. Cl. B41J 2/14; B41J 2/045; B41J 2/16

(52) U.S. Cl. CPC B41J 2/1404; B41J 2/0458; B41J 2/14056; B41J 2/14145; B41J 2/1601; B41J 2/1628; B41J 2202/12

(57) ABSTRACT

In a liquid ejection head, a circulation flow passage has an inlet in which a liquid to a pressure chamber flows and an outlet from which a liquid from the pressure chamber flows out, the circulation flow passage in which the pressure chamber is arranged between the inlet and the outlet extends such that the inlet, the pressure chamber, and the outlet are aligned in this order, a second energy generating element is disposed on an inlet side than a first energy generating element, and a communication passage allowing an outflow-side common flow passage and an inflow-side common flow passage to communicate with each other has an outflow-side opening in the outflow-side common flow passage and includes an outflow-side communication passage formed on a side surface that is inclined such that the farther from the outflow-side opening in a first direction, the larger a width in a second direction.

### BACKGROUND

### Field of the Technology

The present disclosure relates to a liquid ejection head and a liquid ejection apparatus.

### Description of the Related Art

A circulation type liquid ejection apparatus is known which circulates ink in order to discharge air bubbles in a flow passage in a liquid ejection head and suppress increase in viscosity of ink near an ejection port. As a method of circulating ink, there is a differential pressure system using a pressure difference. In the differential pressure system, by using a pressure adjustment mechanism or the like, the pressure of the inner side supplying ink to an ejection port is caused to be higher than the pressure of the outer side collecting the ink, whereby the ink is caused to flow from the inner side to the outer side. At this point of time, to circulate the ink, it is useful to return the ink that has flowed to the outer side to the inner side, and a pump can be used as a mechanism for that purpose. Note that a pump may be provided outside of the head of the recording apparatus main body to circulate the liquid between a liquid ejection head and the main body, or a pump may be provided inside of the liquid ejection head to circulate the liquid in the liquid ejection head. However, such a differential-pressure circulation method requires mechanisms such as a pressure adjusting mechanism and a pump, and therefore, the recording apparatus main body and the head easily become larger in size.

Thus, methods for circulating ink other than the differential pressure system have been reviewed. More specifically, in addition to a first energy generating element generating energy for ejecting ink, a second energy generating element generating energy for causing liquid to flow is arranged in an individual flow passage communicating with the ejection port. A mechanism circulating ink by driving the second energy generating element and causing the ink to flow in an individual flow passage is known. Japanese Patent Application Publication No. 2020-104312 discloses a configuration in which a flow passage extending in a direction intersecting with an ejection port row, in which a plurality of ejection ports is arranged, is provided, and the first energy generating element and the second energy generating element are included in the flow passage.

Here, there is room for improvement in ejection characteristics and circulation characteristics of ink as a recording liquid in a chip configuration, which includes an element generating ejection energy and an element generating flow energy, included in the liquid ejection head disclosed in Japanese Patent Application Publication No. 2020-104312.

### SUMMARY

The present disclosure is directed to provide a technique capable of improving ejection characteristics and circulation characteristics of a liquid in a liquid ejection head including an energy generating element for ejecting the liquid and an energy generating element for causing the liquid to flow.

To address these issues, a liquid ejection head according to some embodiments of the present disclosure includes features characterized as a liquid ejection portion configured to have a pressure chamber, an ejection port used for ejecting liquid from the pressure chamber, and a first energy generating element generating energy for ejecting the liquid disposed inside of the pressure chamber from the ejection port; a circulation flow passage configured to have an inlet in which the liquid supplied to the pressure chamber flows and an outlet from which the liquid collected from the pressure chamber flows out, the circulation flow passage having the pressure chamber arranged between the inlet and the outlet; a second energy generating element configured to be disposed on a side closer to the inlet than the first energy generating element in the circulation flow passage; and a common flow passage configured to include an outflow-side common flow passage, an inflow-side common flow passage, and a communication passage, the outflow-side common flow passage being formed outside of the outlet, the inflow-side common flow passage being formed outside of the inlet, and the communication passage allowing the outflow-side common flow passage and the inflow-side common flow passage to communicate with each other, wherein the ejection port is opened in a first direction, wherein the inlet is positioned on one side of the pressure chamber in a second direction intersecting with the first direction, wherein the outlet is positioned on the other side of the pressure chamber in the second direction, wherein the circulation flow passage extends in the second direction such that the inlet, the pressure chamber, and the outlet are aligned in this order in the second direction, and wherein the communication passage has an outflow-side opening that is opened in the first direction in the outflow-side common flow passage and includes an outflow-side communication passage, and the outflow-side communication passage is formed on a side surface inclined such that the farther from the outflow-side opening in the first direction, the larger a width in the second direction.

Features of the present disclosure will become apparent from the following description of embodiments with reference to the attached drawings. The following description of embodiments are described by way of example.

### BRIEF DESCRIPTION OF THE DRAWINGS

FIG. 1A is a perspective view illustrating the configuration of a liquid ejection apparatus of a case in which a main ink tank is disposed outside of a liquid ejection head according to Example 1.

FIG. 1B is a perspective view illustrating the configuration of a liquid ejection apparatus including an ink tank in a liquid ejection head.

FIG. 2A is an exploded perspective view illustrating a liquid ejection head according to Example 1.

FIG. 2B is a diagram illustrating a configuration in which an ejection port row of ink of four colors is disposed in one liquid ejection chip, and ink of four colors can be ejected using one liquid ejection chip.

FIG. 2C is a diagram illustrating a configuration in which ejection ports of ink of two colors are disposed in one liquid ejection chip, and ink of four colors can be ejected using two liquid ejection chips.

FIG. 2D is a diagram illustrating a configuration in which an ejection port of ink of one color is disposed in one liquid ejection chip, and ink of four colors can be ejected using four liquid ejection chips.

FIG. 3A is a diagram illustrating a configuration near an ejection port of a liquid ejection head in a straight-type ink circulation configuration according to Example 1 and is a diagram illustrating major constituent elements of a case in which the liquid ejection head is seen in a Z direction.

FIG. 3B is a cross-sectional view taken along line AA in FIG. 3A.

FIG. 3C is a cross-sectional view of a liquid ejection head, which has a configuration different from that illustrated in FIG. 3B, taken along line AA.

FIG. 3D is a cross-sectional view taken along line AA in FIG. 3A and is a diagram illustrating the flow of ink of a case in which ink is ejected from an ejection port.

FIG. 4A is a diagram illustrating an appearance of generation of air bubbles by driving a second energy generating element (a circulating heater) in a straight-type ink circulation configuration according to Example 1.

FIG. 4B is a diagram illustrating the flow of ink in an air bubble shrinking process in the straight-type ink circulation configuration according to Example 1.

FIG. 4C is a diagram illustrating the flow of ink after removal of air bubbles in the straight-type ink circulation configuration according to Example 1.

FIG. 5A is a diagram illustrating a state in which a recording operation using a liquid ejection apparatus is temporarily suspended in the straight-type ink circulation configuration according to Example 1.

FIG. 5B is a diagram illustrating a state acquired immediately after a circulation flow is generated by a second energy generating element after FIG. 5A.

FIG. 5C is a diagram illustrating a state of a case in which a recording operation is temporarily suspended again after FIG. 5B.

FIG. 5D is a diagram illustrating a state acquired immediately after a circulation flow is generated again by a second energy generating element after FIG. 5C.

FIG. 6A is a diagram illustrating a state of a case in which a recording operation using a liquid ejection apparatus is temporarily suspended in a U-shaped ink circulation configuration of a comparative example.

FIG. 6B is a diagram illustrating a state acquired immediately after a circulation flow is generated again by a second energy generating element after FIG. 6A.

FIG. 6C is a diagram illustrating a state of a case in which a recording operation is temporarily suspended again after FIG. 6B.

FIG. 6D is a diagram illustrating a state acquired immediately after a circulation flow is generated again by a second energy generating element after FIG. 6C.

FIG. 7A is a diagram illustrating a configuration near an ejection port of a liquid ejection head in a U-shaped ink circulation configuration of a comparative example.

FIG. 7B is a cross-sectional view taken along line AA in FIG. 7A.

FIG. 7C is a diagram illustrating a place near an individual flow passage in FIG. 7A.

FIG. 8 is a diagram illustrating a control configuration of a liquid ejection apparatus according to Example 1.

FIG. 9A is a plan view of a liquid ejection head according to Example 1 that is seen from an ejection port in a direction in which liquid droplets are ejected.

FIG. 9B is a cross-sectional view taken along the direction of arrow A in FIG. 9A.

FIG. 10A is a plan view of a liquid ejection head according to Example 2 that is seen in a direction in which liquid droplets are ejected from an ejection port.

FIG. 10B is a cross-sectional view taken along the direction of arrow B illustrated in FIG. 10A.

FIG. 11A is a cross-sectional view of a liquid ejection head according to Modification 1 of Example 2.

FIG. 11B is a cross-sectional view of a liquid ejection head according to Modification 2 of Example 2.

FIG. 12A is a diagram illustrating an initial state of a substrate of a liquid ejection head in a manufacturing process of the liquid ejection head according to Example 2.

FIG. 12B is a diagram illustrating a state in which a plurality of holes is formed by performing a plurality of times of laser processing on the rear face side of the substrate in the manufacturing process of the liquid ejection head according to Example 2.

FIG. 12C is a diagram illustrating a state in which the substrate after laser processing is immersed in an etching solution to cause anisotropic etching to proceed with the plurality of holes as starting points and form recesses in the manufacturing process of the liquid ejection head according to Example 2.

FIG. 12D is a diagram illustrating a state in which the recesses are processed to communicate with the surface side of the substrate in the manufacturing process of the liquid ejection head according to Example 2.

FIG. 12E is a diagram illustrating a state in which a film is attached to the rear face side of the substrate in the manufacturing process of the liquid ejection head according to Example 2.

FIG. 12F is a diagram illustrating a state in which a dry etching surface resist patterning is formed on the surface side of the substrate, and etching processing is caused to proceed in the manufacturing process of the liquid ejection head according to Example 2.

FIG. 12G is a diagram illustrating a state in which the holes that are opened in the dry etching illustrated in FIG. 12F are caused to communicate with an outflow-side common flow passage that has been opened in advance and are formed as inflow-side common flow passages in the manufacturing process of the liquid ejection head according to Example 2.

FIG. 12H is a diagram illustrating a state in which the film on the rear face side of the substrate is peeled off, and the process ends.

FIG. 13 is a block diagram illustrating a control configuration of the liquid ejection apparatus according to Example 1.

### DESCRIPTION OF THE EMBODIMENTS

In the following, various exemplary embodiments, features, and aspects of the present disclosure will be described in detail with reference to the accompanying drawings. Note that the following embodiments do not limit the subject matter of the present disclosure, and not all of the combinations of features described in the embodiments are necessarily essential to the solution according to the present disclosure. The same components are denoted by the same reference numerals. In the description below, a basic configuration according to the present disclosure is first explained, followed by explanation of characteristic components according to the present disclosure.

### Example 1

A liquid ejection apparatus 50 according to Example 1 of the present disclosure will now be described. The liquid ejection apparatus 50 is an inkjet recording apparatus that uses an inkjet recording method, and includes a liquid ejection head 1 capable of ejecting ink as a liquid.

### Liquid Ejection Apparatus

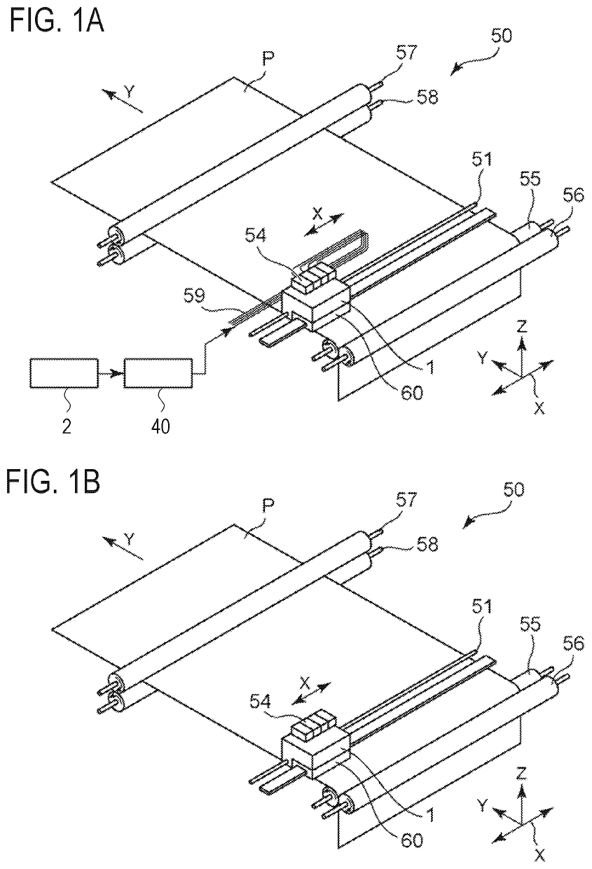

FIGS. 1A and 1B are perspective views illustrating the configurations of liquid ejection apparatuses 50 according to Example 1. The liquid ejection apparatuses 50 illustrated in FIGS. 1A and 1B are liquid ejection apparatuses of a form in which image recording is performed by ejecting a liquid onto a recording medium P using a liquid ejection head 1 scanning in a direction intersecting with a conveyance direction of the recording medium P (a serial-type liquid ejection apparatus). The present disclosure is not limited to the serial-type liquid ejection apparatus and can be applied also to a liquid ejection apparatus of a page wide-type in which image recording is performed by ejecting liquid onto a recording medium conveyed in a conveyance direction using a line head (a page wide-type head) that is long in a page width direction of the recording medium. The liquid ejection head 1 according to Example 1 can eject ink of four types including black (K), cyan (C), magenta (M), and yellow (Y) and record a full-color image using such ink. The ink that can be ejected from the liquid ejection head 1 is not limited to the ink of four types described above. The present disclosure can be applied also to a liquid ejection head that can eject ink of other types, and the types and the number of inks ejected from the liquid ejection head are not particularly limited.

In the liquid ejection apparatus 50, the liquid ejection head 1 is mounted in a carriage 60. The carriage 60 reciprocates along a guide shaft 51 in a main scanning direction (X direction). A recording medium P is conveyed by conveyance rollers 55, 56, 57, and 58 that are conveyance units in a sub scanning direction (Y direction) intersecting with the main scanning direction. In Example 1, the main scanning direction and the sub scanning direction are orthogonal to each other. In each drawing referred to below, a Z direction represents a vertical direction and intersects with an X-Y plane that is defined by an X direction and a Y direction. In Example 1, the Z direction intersects with the X-Y plane.

FIG. 1A illustrates a configuration in which a main ink tank 2 as a liquid storage portion is provided outside of the liquid ejection head 1. The ink stored in the main ink tank 2 is supplied to a sub-ink tank 54 of the liquid ejection head 1 side through an ink supply tube 59 and the like by a drive force of an external pump 40. On the other hand, FIG. 1B illustrates a configuration in which no main ink tank 2 is provided outside of the liquid ejection head 1, and an ink tank 54 is included in the liquid ejection head 1. This configuration may be a configuration in which the liquid ejection head 1 is provided integrally with the ink tank 54 and is attachable/detachable to/from the carriage 60. In addition, a configuration in which the liquid ejection head 1 is provided integrally with the carriage 60, and only the ink tank 54 is attachable and detachable may be employed. The external pump 40 supplying ink to the ink tank 54 is a supply unit for supplying ink to the liquid ejection head 1. Example 1 is described for the configuration illustrated in FIG. 1A as an example.

The liquid ejection head 1 is configured to include individual ejection units to be described below. Although a specific configuration is described below, the individual ejection unit is a recording element unit in which an ejection port used for ejecting liquid, and an individual flow passage communicating with the ejection port are formed. A pressure chamber is formed at a position corresponding to the ejection port of the individual flow passage, and a first energy generating element (ejection energy generating element) generating energy for ejecting liquid from the ejection port is provided in the pressure chamber. At a position different from that of the first energy generating element in the individual flow passage, a second energy generating element (flow energy generating element) generating energy for causing liquid to flow is provided. The liquid ejection head 1 includes a plurality of individual ejection units, and has a supply flow passage for supplying the liquid to the individual flow passage in each individual ejection unit.

There are cases in which ejection of liquid becomes unstable due to evaporation of volatile components such as moisture and the like of liquid from the ejection port of the liquid ejection head 1, concentration of solid contents near the ejection port according thereto, and the like, and, in order to prevent that, various countermeasures have been considered. For example, in the liquid ejection apparatus 50, a cap member (not illustrated), which is capable of covering an ejection port surface on which the ejection port of the liquid ejection head 1 is formed, may be provided at a position offset from the conveyance passage of the recording medium P in the X direction. The cap member covers the ejection port surface of the liquid ejection head 1 when a recording operation is not being performed or the like and is used for preventing the ejection port from being dried and protection of the ejection port.

In addition, an ink suction mechanism (not illustrated) may be provided. In a case in which the ink suction mechanism is provided, the cap member is used in an ink suctioning operation for suctioning ink from the ejection port and the like. By performing this ink suctioning operation, it is possible to refresh the ink near the ejection opening and to maintain the image quality of images achieved.

Furthermore, it is also possible to discard the thickened ink by executing ejection that is called preliminary ejection (pre-ejection) while the recording operation is not being performed. Such preliminary ejection may be performed also during the recording operation with an unnoticeable amount of ink at an unnoticeable position on a recording medium in terms of the image quality (paper sheet preliminary ejection/in-page preliminary ejection). Although such methods greatly contribute to improvement of image quality, it is required to reduce the amount of waste ink, because some of the ink is discarded to refresh the ejection port.

In relation to this demand, by providing a second energy generation element (fluid energy generation element) in the individual flow passage and circulating the ink through the flow passage, it is possible to inhibit drying of the ejection opening and thickening of the ink near the ejection opening, while suppressing the amount of waste ink. More specifically, the number of times preliminary ejection or suction recovery is performed can be reduced. Further, by reducing the number of preliminary ejection operations and the like, the throughput and the yield thereof can be improved.

The second energy generation element does not need to be provided to all the individual ejection units of the liquid ejection head. In a case where the second energy generating element is provided in some of the individual ejection units, the above-described effect can be achieved more effectively than in a case where no second energy generating elements are provided.

It is also possible for the liquid ejection head 1 to have a configuration in which all the parts respectively corresponding to the four inks are provided with the second energy generation elements, or a configuration in which only a part corresponding to one of the inks is provided with the second energy generation elements. The liquid ejection head 1 may be configured to circulate not all the four types of ink, but only at least one type of ink.

### Liquid Ejection Head

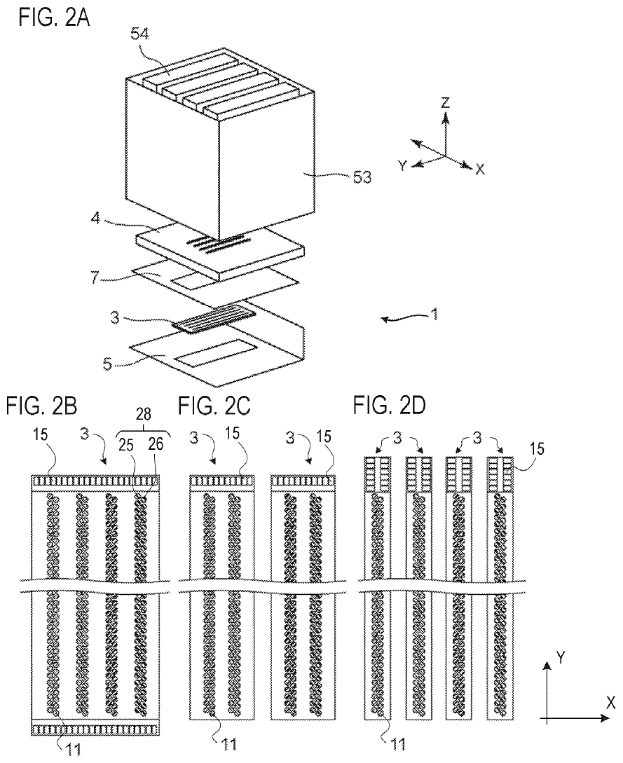

The configuration of the liquid ejection head 1 according to Example 1 will now be explained. FIGS. 2A to 2D are diagrams illustrating the configuration of the liquid ejection head 1 according to Example 1. FIG. 2A is an exploded perspective view of the liquid ejection head 1.

The liquid ejection head 1 includes four sub-ink tanks 54 for temporarily storing the inks and a liquid ejection chip 3 for causing the inks supplied from the sub-ink tanks 54 to be ejected onto a recording medium P.

The liquid ejection head 1 also includes a first support member 4, a second support member 7, and an electric wiring member 5 (electric wiring tape). The liquid ejection chip 3 is connected to one surface of the first support member 4, and the sub-ink tanks 54 are connected to the other surface. The first support member 4 has flow passages passing therethrough from the one surface to the other surface, and the first support member 4 passes the ink supplied from the sub-ink tank 54 to the liquid ejection chip 3, while supporting the liquid ejection chip 3.

The second support member 7 is connected to the first support member 4 on the surface where the liquid ejection chip 3 is connected. The second support member 7 has an opening through which the liquid ejection chip 3 can pass, and the second support member 7 is connected to the first support member 4 with the liquid ejection chip 3 positioned inside of the opening. The second support member 7 also serves to support the electric wiring member 5.

The electric wiring member 5 is electrically connected to the liquid ejection chip 3, and sends ejection signals for ejecting the ink, received from the main body of the liquid ejection apparatus 50 or the like, to the liquid ejection chip 3.

The liquid ejection head 1 according to Example 1 is fixed to and supported by the carriage 60 of the liquid ejection apparatus 50, via an alignment unit and electrical contacts (not illustrated) provided to the carriage 60. The liquid ejection head 1 carries out recording on the recording medium P by moving with the carriage 60 in the main scanning direction (X direction) while ejecting ink.

Ink supply tubes 59 are provided on the external pumps 40 connected to the main ink tanks 2, each of which serves as an ink supply source (refer to FIG. 1A). A liquid connector (not shown) is provided at the tip end of the ink supply tube 59. When the liquid ejection head 1 is mounted on the liquid ejection apparatus 50, the liquid connector provided at the end of the ink supply tube 59 is liquid-tightly connected to a liquid connector insertion port that is a liquid introduction port provided in a casing of the liquid ejection head 1. As a result, an ink supply passage is formed from the ink tank 2 to the liquid ejection head 1 via the external pump 40. In Example 1, because four inks are used, four sets of the ink tank 2, the external pump 40, the ink supply tube 59, and the sub-ink tank 54 are provided in total in correspondence with respective inks. Four ink supply channels corresponding to respective inks are independently formed.

As described above, the liquid ejection apparatus 50 is provided with an ink supply system for supplying ink from the ink tank 2 external of the liquid ejection head 1. Note that the liquid ejection apparatus 50 is not provided with an ink collection system for collecting the ink from the liquid ejection head 1 into the ink tank 2. Therefore, despite being provided with a liquid connector insertion port for connecting the ink supply tube 59 of the ink tank 2, the liquid ejection head 1 is not provided with a connector insertion port for connecting a tube for collecting the ink from the liquid ejection head 1 into the ink tank 2. The liquid connector insertion ports are provided correspondingly to the respective inks.

FIGS. 2B, 2C, and 2D are diagrams illustrating configuration examples of liquid ejection chips 3 constituting the liquid ejection head 1. In each liquid ejection chip 3, an ejection port 11 and a pad 15 used for electrical mounting are provided. FIG. 2A is illustrated in a chip configuration of FIG. 2B.

The liquid ejection head 1 can eject ink of four colors. The four colors are, for example, black, cyan, magenta, and yellow. In the liquid ejection chip 3, an ejection port row 28 is formed for each color of ink. One ejection port row 28 is composed of a first row 25 and a second row 26 each composed of a plurality of ejection ports 11 arranged at equal intervals in the Y direction, and the first row 25 and the second row 26 are arranged to be aligned in the X direction. The ejection ports 11 included in the first row 25 and the ejection ports 11 included in the second row 26 are displaced from each other in the Y direction. Although the configuration in which the ejection port row 28 is composed of a plurality of ejection ports 11 aligned in two rows is illustrated, a configuration in which the ejection port row 28 is composed of a plurality of ejection ports 11 aligned in one row may be employed.

FIG. 2B illustrates a configuration in which ejection port rows 28 of inks of four colors are disposed in one liquid ejection chip 3, and one liquid ejection chip 3 can eject four colors of ink. In addition, a configuration in which two rows of ejection port rows 28 are provided only for black, and five rows of ejection port rows 28 in total are provided in four colors may be employed.

FIG. 2C illustrates a configuration in which ejection ports of inks of two colors are provided in one liquid ejection chip 3, and two liquid ejection chips 3 can eject inks of four colors. As a configuration in which two liquid ejection chips 3 are mounted, two liquid ejection chips 3 may be mounted in one liquid ejection head 1, or two liquid ejection heads 1 in which one liquid ejection chip 3 is mounted may be prepared.

FIG. 2D illustrates a configuration in which one liquid ejection chip 3 is provided with an ejection port of an ink of one color, and four liquid ejection chips 3 can eject inks of four colors. As a configuration in which four liquid ejection chips 3 are mounted, four liquid ejection chips 3 may be mounted in one liquid ejection head 1, and four liquid ejection heads 1 in which one liquid ejection chip 3 is mounted may be prepared.

Further, as illustrated in FIGS. 2C and 2D, in case in which the liquid ejection chip 3 is divided into a plurality of chips, all the chips do not have to have the same chip length. Furthermore, various combinations of other colors for the chips are possible, and the same applies in a case where the total number of colors is larger than four.

### Straight-type Ink Circulation Configuration

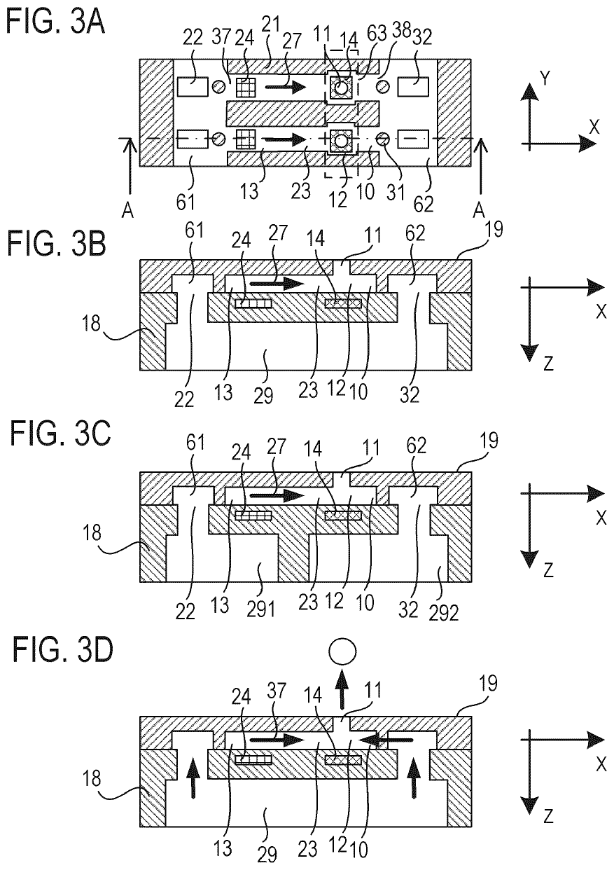

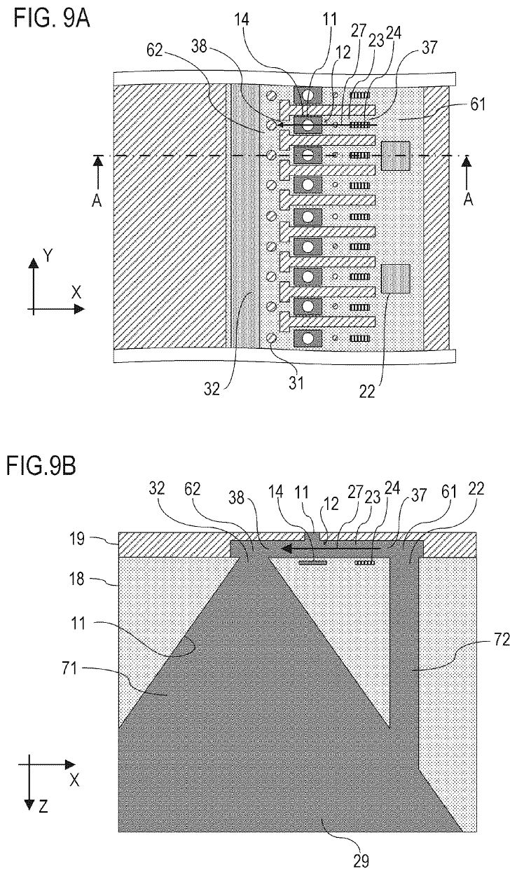

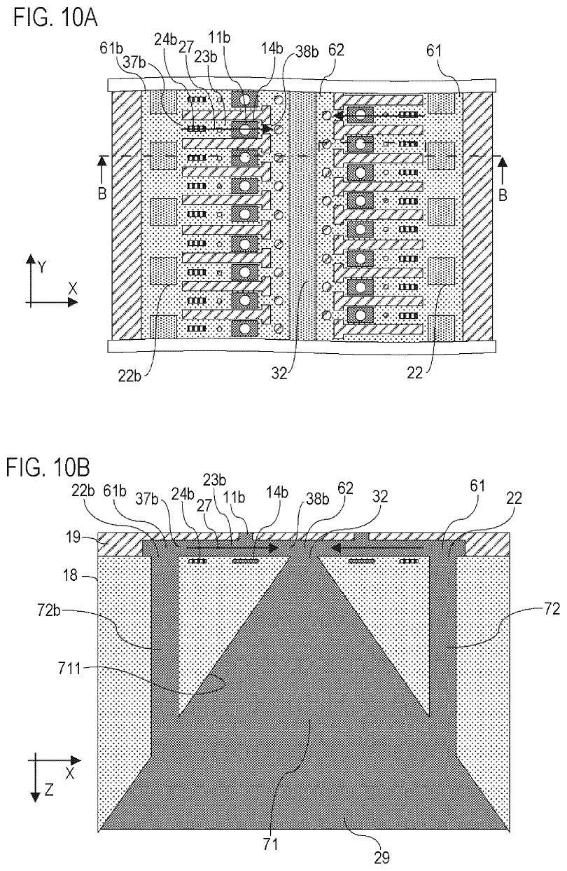

FIGS. 3A to 3D to FIGS. 5A to 5D are diagrams illustrating a straight-type ink circulation configuration according to Example 1. FIGS. 3A to 3D to FIGS. 5A to 5D are simplified diagrams for explaining a generation mechanism of a circulation flow and effects thereof in the straight-type ink circulation configuration. Thus, the configuration of the liquid ejection head 1 shown in FIGS. 3A to 3D to FIGS. 5A to 5D is partially different from the configuration of the liquid ejection head 1 according to Example 1 (described below with reference to FIGS. 9A and 9B and FIGS. 10A and 10B).

However, the mechanism of generating ink circulation and its effects described with reference to FIGS. 3A to 3D to FIGS. 5A to 5D are similar also in the liquid ejection head 1 according to Example 1. In addition, among the following descriptions referring to FIGS. 3A to 3D to FIGS. 5A to 5D, contents applicable to the liquid ejection head 1 according to Example 1 are incorporated as the description of Example 1 unless otherwise indicated.

FIG. 3A is a diagram illustrating a configuration near the ejection port 11 of the liquid ejection head 1 and is a diagram illustrating major constituent elements of a case in which the liquid ejection head 1 is seen in the Z direction. FIG. 3B is a cross-sectional view taken along line AA in FIG. 3A. FIG. 3C is a cross-sectional view taken along line AA in FIG. 3A and is a cross-sectional view of a liquid ejection head 1 having a configuration different from that illustrated in FIG. 3B. FIG. 3D is a cross-sectional view taken along line AA in FIG. 3A and is a diagram illustrating the flow of ink of a case the ink is ejected from the ejection port.

The liquid ejection head 1 has a stacked substrate 18 and an orifice plate 19, and an ejection port row 63 composed of a plurality of ejection ports 11 arranged in the Y direction is formed in the orifice plate 19. An ink meniscus is spread on the ejection ports 11, and an ejection port interface as the interface between the ink and the atmosphere is formed.

Between the substrate 18 and the orifice plate 19, a plurality of individual flow passages 23 that is separated by partition walls 21, communicates with a plurality of ejection ports 11, and extend in the X direction is formed. The individual flow passage 23 linearly extends in the X direction orthogonal to the Y direction in which the plurality of ejection ports 11 is aligned in the ejection port row 63.

In addition, a first flow passage 61 with which one ends of the plurality of individual flow passages 23 communicate and a second flow passage 62 with which the other ends of the plurality of individual flow passages 23 communicate are formed. The first flow passage 61 and the second flow passage 62 extend in the Y direction and are located on sides opposite to each other in the X direction with the ejection port row 63 interposed therebetween.

In the individual flow passage 23, a pressure chamber 12 is formed at a position corresponding to the ejection port 11. The pressure chamber 12 communicates with the first flow passage 61 through a connection flow passage 13 and communicates with the second flow passage 62 through a connection flow passage 10. In other words, the individual flow passage 23 includes the pressure chamber 12, the connection flow passage 10, and the connection flow passage 13.

In the substrate 18, a first energy generating element 14 (ejection energy generating element) that generates energy for ejecting ink disposed inside of the pressure chamber 12 is provided at a position corresponding to the ejection port 11. Here, an electrothermal conversion element is used as the first energy generating element 14. By driving the first energy generating element 14 to generate heat and cause the ink disposed inside of the pressure chamber 12 to generate air bubbles, ink can be ejected from the ejection port 11 using the bubbling energy. The first energy generating element 14 is not limited to electrothermal conversion element, and a piezoelectric element or the like can be used.

In addition, a second energy generating element 24 (a flow energy generating element) for generating energy to generate a circulation flow 27 (flow) indicated by arrows in the ink disposed inside of the individual flow passage 23 is provided in the substrate 18. Here, an electrothermal conversion element is used as the second energy generating element 24. The second energy generating element 24 is provided at a position different from that of the first energy generating element 14 in the X direction.

In the first flow passage 61, a plurality of first openings 22 for allowing ink to flow in/out into/from a common flow passage 29 is arranged in the Y direction. In the second flow passage 62, a plurality of second openings 32 for allowing ink to flow in/out into/from the common flow passage 29 is arranged in the Y direction. The first openings 22 and the second openings 32 penetrate through the substrate 18 in a stacking direction.

The first energy generating element 14, the ejection port 11, and the pressure chamber 12 are located closer to the second opening 32 than to the first opening 22. The second energy generating element 24 is located closer to the first opening 22 than to the second opening 32. The individual flow passage 23 communicates with the first opening 22 on the one end side in the X direction (the −X direction side) and communicates with the second opening 32 on the other end side (the +X direction side). The connection flow passage 13 is located on the second energy generating element 24 side of the ejection port row 63 in the X direction. Both ends of the individual flow passage 23 in the X direction are located on sides opposite to each other with the ejection port row 63 interposed therebetween.

There are primarily two types of ink flow in the individual flow passage 23. That is, (1) a first ink flow for refilling after ink ejection that is driven by the first energy generating element 14 and (2) a second ink flow that is a circulation flow 27 generated by driving the second energy generating element 24.

In a case in which the first energy generating element 14 is driven, and ink is ejected from the ejection port 11, as shown in FIG. 3D, the flow 27 of ink flowing from both the first opening 22 and the second opening 32 into the pressure chamber 12 of the individual flow passage 23 is generated. In accordance with this, ink is supplied to the individual flow passage 23 from both the first opening 22 and the second opening 32.

In a case in which the second energy generating element 24 is driven, and the circulation flow 27 is formed, ink flows from an inlet 37 of the connection flow passage 13 side (the first opening 22 side) into the individual flow passage 23, and ink flows out from an outlet 38 of the connection flow passage 10 side (the second opening 32 side). The ink that has flown out from the second opening 32 is returned to the first opening 22 through the common flow passage 29. In accordance with this, a circulation flow 27 indicated by arrows is generated inside of the individual flow passage 23.

In the configuration shown in FIG. 3B, the first opening 22 and the second opening 32 are connected to the common flow passage 29 inside of the chip of the liquid ejection head 1. In the configuration shown in FIG. 3C, the first opening 22 and second opening 32 are connected to a flow passage 291 and a flow passage 292, which are independent, inside of the chip of the liquid ejection head 1 and are connected to a common flow passage outside of the chip of the liquid ejection head 1. The present disclosure is applicable to any one of the configurations.

A filter for removing foreign materials inside of ink can be provided in circulation flow passages of the ink inside and outside of the liquid ejection head 1. In the example shown in FIGS. 3A to 3D, filters 31 are provided near the end of the one-end side (the second energy generating element 24 side) of the individual flow passage 23 in the X direction and near the end of the other end side (the first energy generating element 14 side). In addition, a filter may be arranged between the first energy generating element 14 and the second energy generating element 24 in the individual flow passage 23. In this case, no filter may be arranged near the end of one end side (the second energy generation element 24 side) of the individual flow passage 23 in the X-direction.

In the liquid ejection head 1, a first energy generating element 14 and a second energy generating element 24 are arranged to be aligned in the X direction inside of an individual flow passage 23 extending linearly in the X direction. By driving the second energy generating element 24, a circulation flow 27 of ink can be generated in the individual flow passage 23. Both ends of the individual flow passage 23 are located on sides opposite to each other in the X direction with respect to the ejection port row 63. For this reason, an inlet 37 (upstream end) and an outlet 38 (downstream end) of the circulation flow 27 are respectively connected to a first flow passage 61 and a second flow passage 62, which are different from each other, and are separated from each other. Such an ink circulation configuration is referred to as a straight type.

### Process of Generating Circulation Flow

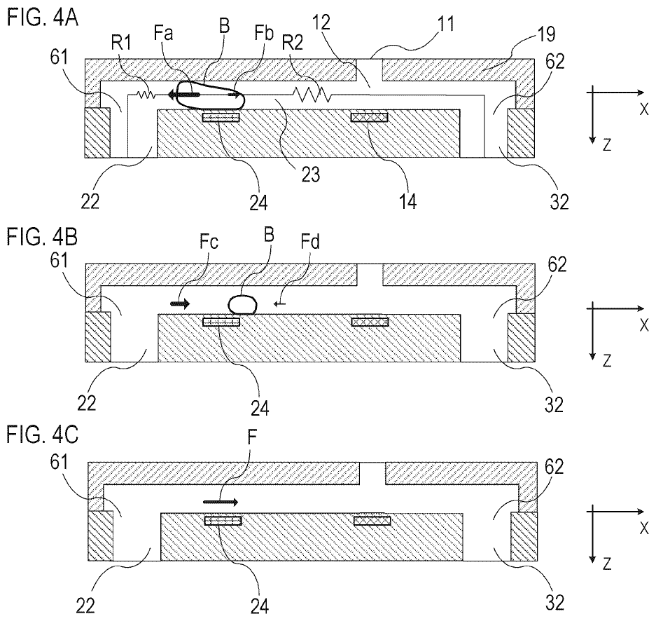

FIG. 4A to 4C are diagrams for explaining the process of generating a circulation flow of ink by driving the second energy generating element 24. FIGS. 4A, 4B, and 4C are cross-sectional views that are similar to FIG. 3B and represent processes in which ink is heated by the second energy generating element 24, and air bubbles due to film boiling or the like of ink are generated, grown, shrunk, and removed.

FIG. 4A is a diagram illustrating a view in which an air bubble B is generated by driving the second energy generating element 24 (a circulation heater). The second energy generating element 24 is located closer to the first opening 22 than to the second opening 32. For this reason, a flow resistance R1 between the second energy generating element 24 and the first opening 22 is less than a flow resistance R2 between the second energy generating element 24 and the second opening 32. In FIG. 4A, an equivalent circuit that expresses such flow resistances R1 and R2 as electrical resistances is drawn. The air bubble B generated due to film boiling of ink film and the like, as illustrated in FIG. 4A, grows with being biased toward the first flow passage 61 side of the small flow resistance R1 in accordance with a difference between the flow resistances R1 and R2. Thus, inside of the individual flow passage 23, a flow Fa of ink toward the first flow passage 61 becomes larger than a flow Fb of ink toward the second flow passage 62.

FIG. 4B is a diagram illustrating the flow of ink in the process of shrinkage of the air bubble B. In the shrinkage process of the bubble B, the ink flows in to compensate for a volume corresponding to the shrinkage. At that time, as illustrated in FIG. 4B, a flow Fc of the ink flowing in from the first opening 22 on a side having the small flow resistance R1 is greater than a flow Fd of the ink flowing in from the second opening 32 on a side having the large flow resistance R2. Further, the removal position of the air bubble B deviates from the second energy generating element 24 to the second opening 32 side.

FIG. 4C is a diagram illustrating the flow of the ink after the removal of the air bubble B. According to a relationship Fc>Fd generated in FIG. 4B, a circulation flow F of the ink from the first opening 22 toward the second opening 32 is generated.

The magnitude of such a circulation flow F is influenced by the ratio of the flow resistances R1 and R2 and the size of the air bubble B. For example, when an electrothermal conversion element (heater) is used as the second energy generating element 24, the second energy generating element 24 may be located closer to one of the both ends of the individual flow passage 23 than the first energy generating element 14. More specifically, the flow resistance ratio R1/R2 may be set in the range of at least 0.05 and not more than 0.40. By setting the flow resistance ratio R1/R2 in the range, the circulation flow F can be maximized.

By increasing the flow Fa of the ink toward the first flow passage 61 illustrated in FIGS. 4A and 4B and increasing the flow Fc of the ink flowing in from the first opening 22, the circulation flow F can be increased. Therefore, it is effective to reduce the flow resistance R1. In addition, by decreasing the flow Fb of the ink toward the second flow passage 62 and decreasing the flow Fd of the ink flowing in from the second opening 32, the circulation flow F can be increased. Therefore, it is effective to increase the flow resistance R2. As described above, by decreasing the flow resistance R1 and increasing the flow resistance R2, that is, by decreasing the flow resistance ratio R1/R2, the circulation flow F can be increased. Here, although the adjustment of the flow resistance ratios R1 and R2 is not limited to a specific method, they may be adjusted, for example, by changing the position of the second energy generating element 24 in the individual flow passage 23. In other words, for example, there is a method in which the magnitudes of the flow resistance R1 and the flow resistance R2 are changed by changing a flow passage distance between the second energy generating element 24 and the first opening 22 and a flow passage distance between the second energy generating element 24 and the second opening 32. Alternatively, a method in which flow passage cross-sections of both sides of the second energy generating element 24 is changed or a method in which both the flow passage distances and the flow passage cross-sections are changed may be used. As a method of changing the flow passage cross-sections, for example, a method in which the flow resistances R1 and R2 are changed by disposing a structure that prevents the flow on the flow passage may be used.

In addition, when the accumulation of the air bubble B increases, the volume of the ink excluded from the individual flow passage 23 according to foaming increases, and thus, the circulation flow F increases. As methods for increasing the volume of the air bubble B, it may be considered to increase the size of the second energy generating element 24, decrease the flow resistance R1 by increasing the width and the height of the connection flow passage 13, reduce the ink viscosity, increase the temperature of the liquid ejection head 1, configuring the drive pulse to be a double pulse, and the like.

Since a part of the circulation flow F of ink enters the ejection port 11, the concentrated ink in the ejection port 11 is sent to the second opening 32 side, and fresh ink flows into the ejection port 11 from the first opening 22 side through the connection flow passage 13. By making the concentrated ink less likely to stay inside of the ejection port 11 in accordance with this, it is possible to suppress the influence of the concentrated ink and maintain the initial ink ejecting state.

The circulation flow F is a transient flow generated in accompaniment with the growth and shrink processes of the generated air bubbles B. Therefore, the inertial flow of the air bubbles B after removal of bubbles becomes weaker over time, and stops after a certain period of time. By repeatedly driving the second energy generating element 24, the circulation flow F can be generated steadily for a certain period of time. The driving cycle of the second energy generating element 24 is not particularly limited as long as the concentrated ink in the ejection port 11 can be discharged. However, since a time from the generation of the air bubbles B to the removal of bubbles is about 10 microseconds (μs), driving at a high drive frequency such as 100 kilohertz (kHz) reduces the effects. Accordingly, the second energy generating element 24 may be driven, for example, at the period of about 100 Hz to several tens of kHz. The higher the drive frequency, the more the circulation flow F is stably maintained, and the greater the effect of discharging the concentrated ink. On the other hand, it is useful to consider the rise in temperature of the ink due to the heat generated in accompaniment with the driving of the second energy generating element 24. For this reason, the number of times of driving of the second energy generating element 24 may be appropriately controlled.

Although an example in which an electro-thermal conversion element is used as the second energy generating element 24 has been illustrated in the description presented above, a piezo element may be used as the second energy generating element 24. In the case of the piezo element, the direction of the circulation flow may be opposite to that described above depending on the drive method thereof.

### U-shaped Ink Circulation Configuration

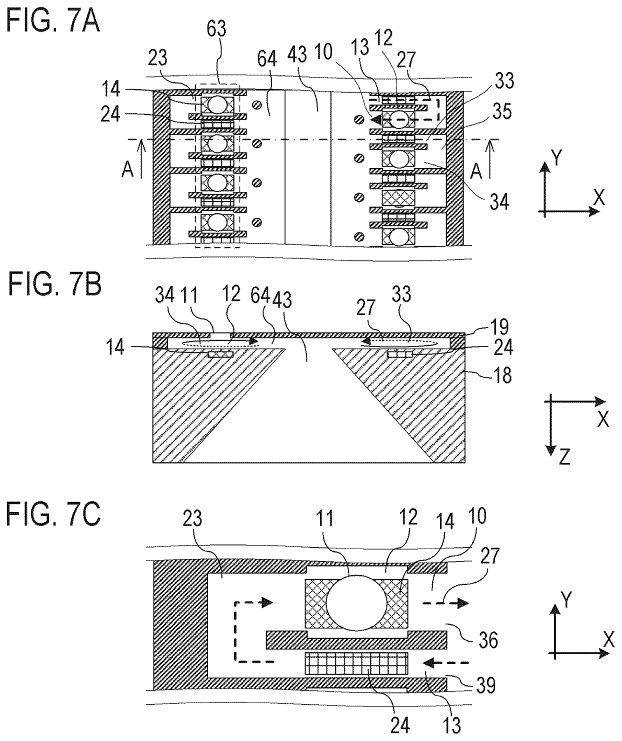

A U-shaped ink circulation configuration is described as a comparative example of the straight-type ink circulation configuration. FIGS. 7A to 7C are diagrams illustrating a liquid ejection head of a comparative example. FIG. 7A is a diagram illustrating a configuration near an ejection port 11 of the liquid ejection head of the of the comparative example and is a diagram illustrating major constituent elements of a case in which the liquid ejection head 1 is seen in the Z direction. FIG. 7B is a cross-sectional view taken along line AA in FIG. 7A. FIG. 7C is a diagram illustrating the vicinity of an individual flow passage in FIG. 7A.

The liquid ejection head of the comparative example has a stacked substrate 18 and an orifice plate 19, and an ejection port row 63 composed of a plurality of ejection ports 11 arranged in the Y direction is formed in the orifice plate 19. A first energy generating element 14 and a second energy generating element 24 are alternately arranged in parallel with the ejection port row 63.

Between the substrate 18 and the orifice plate 19, a plurality of individual flow passages 23 that are partitioned by partition walls 21, communicate with a plurality of ejection ports 11, and formed in a U-shape are formed. The individual flow passage 23 has a first part 33 and a second part 34, which extend in the X direction, and a third part 35 connecting one end sides of the first part 33 and the second part 34 in the X direction and extending in the Y direction. The other end sides of the first part 33 and the second part 34 in the X direction communicate with the flow passage 64, and the flow passage 64 communicates with the common flow passage 43. Both ends of the individual flow passage 23 are adjacent to each other in the Y direction and communicate with the flow passage 64 on the same side (single side) in the X direction. The common flow passage 43 is disposed to penetrate through the substrate 18.

The second energy generating element 24 is disposed in the first part 33, and the pressure chamber 12 and the first energy generating element 14 are disposed in the second part 34. The individual flow passage 23 is a flow passage formed through U-shaped bending so as to connect the first energy generating element 14 and the second energy generating element 24 arranged to be aligned in the Y direction.

In the individual flow passage 23, a pressure chamber 12 is formed at a position corresponding to the ejection port 11. The pressure chamber 12 communicates with the flow passage 64 through the connection flow passage 10 and communicates with the flow passage 64 through the connection flow passage 13. In other words, the individual flow passage 23 includes the pressure chamber 12, the connection flow passage 10, and the connection flow passage 13. The connection flow passage 13 is formed in parts of the first part 33, the third part 35, and the second part 34, and the connection flow passage 10 is formed in a part of the second part 34. The first energy generating element 14 is located near a connection portion between the connection flow passage 10 and the flow passage 64, and the second energy generating element 24 is located near a connection portion between the connection flow passage 13 and the flow passage 64.

As flows of ink in the individual flow passage 23, there are: (1) a first ink flow for refilling after ink is ejected by driving the first energy generating element 14; and (2) a second ink flow that is a circulation flow 27 generated by driving the second energy generating element 24.

In a case in which ink is ejected from the ejection port 11 by driving the first energy generating element 14, in order to supply ink accompanying ejection from the common flow passage 43, ink is caused to flow from both the connection flow passage 10 side and the connection flow passage 13 side into the pressure chamber 12.

In a case in which the circulation flow 27 is formed by driving the second energy generating element 24, ink flows from the inlet 39 of the connection flow passage 13 side into the individual flow passage 23, and ink flows out from the outlet 36 to the connection flow passage 10 side. In accordance with the circulation flow 27 indicated by arrows generated inside of the individual flow passage 23, flowing-in/flowing-out of ink into/from the common flow passage 43 that is common occur. In addition, a configuration for communicating with a common flow passage, which is not illustrated, through a plurality of openings that are disposed in the flow passage 64 and are arranged in the Y direction as illustrated in FIGS. 3A to 3D may be employed. In such a case, the plurality of openings communicates with the common flow passage inside of the chip as illustrated in FIG. 3B.

In the liquid ejection head of the comparative example, inside of the individual flow passage 23 formed in the U-shape, the first energy generating element 14 and the second energy generating element 24 are aligned in the Y direction and are arranged to be aligned along the ejection port row 63. By driving the second energy generating element 24, the circulation flow 27 of ink can be generated inside of the individual flow passage 23. Both ends of the individual flow passage 23 are located on the same side (single side) with respect to the ejection port row 63 in the X direction. For this reason, the inlet 39 (the upstream end) and the outlet 36 (the downstream end) of the circulation flow 27 are connected to the common flow passage 64. Such an ink circulation configuration is referred to as a U-shape.

### Recirculation Concentration

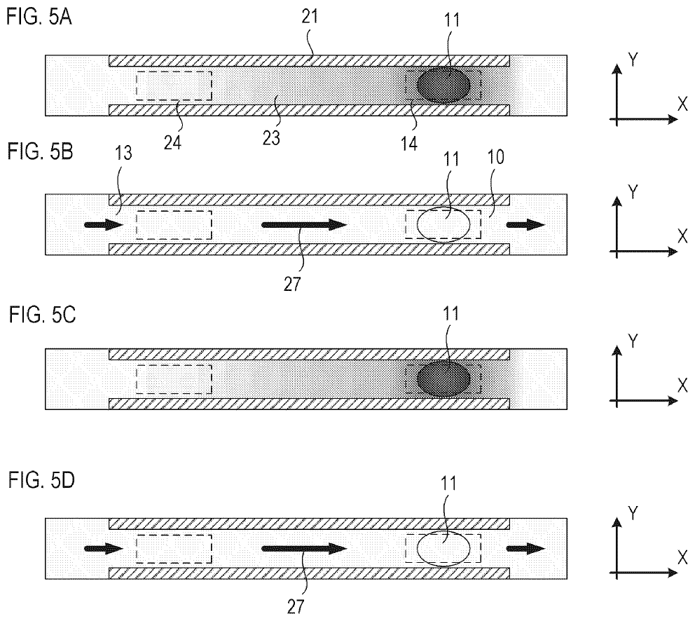

FIGS. 5A to 5D are diagrams illustrating a view of a circulation flow and concentration of ink in the straight-type ink circulation configuration. In FIGS. 5A to 5D, the concentration of the ink is expressed by the density, and the concentration of the dark color part is high.

FIG. 5A illustrates a state of a case in which a recording operation using the liquid ejection apparatus 50 is temporarily suspended. When a recording operation is temporarily suspended, volatile components of ink evaporate from the ejection port 11, and concentration of the ink progresses in the vicinity of the ejection port 11.

FIG. 5B illustrates a state immediately after the circulation flow 27 is caused to be generated by the second energy generating element 24 thereafter. In accordance with the circulation flow 27, the concentration in the vicinity of the ejection port 11 is eliminated. The ink concentrated in the vicinity of the ejection port 11 is discharged from the outlet 38, fresh ink flows in from the inlet 37, and the concentration is eliminated in the entire individual flow passage 23.

FIG. 5C illustrates a state of a case in which the recording operation is temporarily suspended again thereafter. Similar to the state illustrated in FIG. 5A, concentration of the ink progresses in the vicinity of the ejection port 11. FIG. 5D illustrates a state immediately after the circulation flow 27 is caused to be generated by the second energy generating element 24 again thereafter. Similar to the state illustrated in FIG. 5B, the concentration in the vicinity of the ejection port 11 is eliminated, and the concentration is eliminated also in the entire individual flow passage 23.

In this way, in the straight-type ink circulation configuration in which the inlet 37 and the outlet 38 of the individual flow passage 23 are separated, the concentrated state is eliminated also by repeating the temporary suspension and the circulation operation.

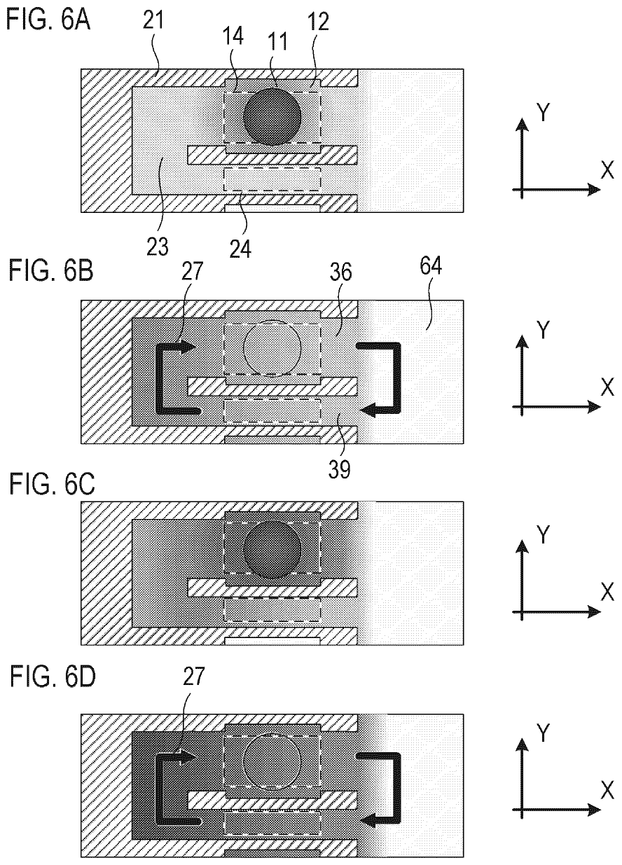

FIGS. 6A to 6D are diagrams explaining a view of a circulation flow and concentration of ink in the U-shaped ink circulation configuration of the comparative example.

FIG. 6A illustrates a state of a case in which the recording operation using the liquid ejection apparatus is temporarily suspended. When the recording operation is temporarily suspended, concentration of ink progresses in the vicinity of the ejection port 11.

FIG. 6B illustrates a state immediately after the circulation flow 27 is caused to be generated by the second energy generating element 24 thereafter. In the U-shaped ink circulation configuration, the inlet 39 and the outlet 36 of the individual flow passage 23 are connected to the common flow passage 64 and are close thereto. For this reason, although the ink concentrated in the vicinity of the ejection port 11 is discharged from the outlet 36 of the individual flow passage 23, the ink may flow from the inlet 39 into the individual flow passage 23 again. In accordance with this, even when the circulation flow 27 is caused to be generated, the ink in the entire individual flow passage 23 is replaced with not fresh ink but slightly concentrated ink. This phenomenon is referred to as re-circulation concentration.

FIG. 6C illustrates a state of a case in which the recording operation is temporarily suspended again thereafter. From the state illustrated in FIG. 6B, concentration of the ink in the vicinity of the ejection port 11 is further progressed.

FIG. 6D illustrates a state immediately after the circulation flow 27 is caused to be generated by the second energy generating element 24 again thereafter. As explained in FIG. 6B, in accordance with the influence of the re-circulation concentration, the ink in the entire individual flow passage 23 is replaced with ink that is more concentrated than that of FIG. 6B.

In this way, in the U-shaped ink circulation configuration in which the inlet 39 and the outlet 36 of the individual flow passage 23 are adjacent to each other, in a case in which the temporary suspension and the circulation operation are repeated, the concentrated state is not eliminated, and the concentration gradually processes in the entire individual flow passage 23. Further, even when the circulation operation is not repeated, the ink may be highly concentrated in the vicinity of the ejection port 11 due to a long stop time period or the like. In such a case, the state of concentration is unlikely to improve even in the first circulation operation. This is because the recirculation concentration is hardly effective in alleviating the degree of the concentrated state.

Accordingly, between the straight-type configuration in which the inlet and the outlet of the individual flow passage are separated from each other and the U-shaped configuration in which the inlet and the outlet of the individual flow passage are adjacent to each other, there is a difference in the aspect of elimination of concentration of a case in which a circulation operation is performed after temporarily suspension in accordance with a difference in the influence of the discharged concentrated ink. In the straight-type configuration, the concentrated state in the entire individual flow passage is easily eliminated, and thus, the ejection stability is hardly degraded by a concentrated ink. On the other hand, in the U-shaped configuration, the concentrated state in the entire individual flow passage is difficult to eliminate due to the recirculation concentration, and therefore, ejection is likely to become unstable depending on the concentration in the entire individual flow passage.

### Ink

By using an electro-thermal conversion element (a circulation heater) as the second energy generating element 24, an ink circulation flow is generated inside of the individual flow passage 23, whereby the influence of the concentrated ink increased in viscosity due to evaporation of the volatile component in the ejection port 11 can be suppressed. In accordance with this, the ejected state of the ink can be maintained well, and the change in the ejection speed and the like can be reduced, whereby the ejection can be stabilized.

Here, depending on the application of the liquid ejection head 1 or the liquid ejection apparatus 50, there may be cases in which the type of the coloring material of the ink to be used, the content of the solid content, and the like are different. For example, in plain paper, it is conceivable to use an ink with a reduced moisture content in order to suppress curling (warping) and cockling (wavy wrinkles) due to water in the ink. In the ink with a low moisture content, it is easy for the viscosity to rapidly increase in accompaniment with evaporation of moisture because the concentration of solid matter such as an organic solvent, a pigment, a resin and the like other than water is high, which is likely to lead to a decrease in the ejection stability of the ink. Generally, an ink with a solid content of 10 percent by weight or mass percent (wt % (mass %)) or more in the ink can be said to be an ink with a high solid content.

In the liquid ejection head 1 according to Example 1, since the circulation flow 27 can be generated inside of the individual flow passage 23 having the pressure chamber 12, even in a case in which ink containing a solid content of 10 wt % (mass %) or more is used in this way, increase in viscosity of the ink can be suppressed. Accordingly, the present disclosure can be appropriately applied to a liquid ejection head 1 and a liquid ejection apparatus 50 using an ink containing a solid content of 10 wt % (mass %) or more. According to the liquid ejection head 1 of Example 1, ejection stability can be maintained well regardless of the type of ink.

In addition, regarding the operating temperature of the liquid ejection head 1, the liquid ejection head may be heated at a constant temperature by arranging a heater in the entire chip and controlling the heater. Since the viscosity of ink varies depending on the temperature, the ink viscosity at the head operating temperature affects the ejection stability.

In the liquid ejection head 1 according to Example 1, the flow rate of the circulation flow 27 that can be formed in the individual flow passage 23 by the second energy generating element 24 is several tens millimeter per second (mm/s) to 1000 mm/s as an instantaneous flow rate. The flow rate averaged over a time width of the order of several 100 μ seconds depends on the drive frequency of the second energy generating element 24. This is because the circulation flow 27 generated by the second energy generating element 24 is a transient flow that damps over time and stops after a predetermined time. The average flow rate of the circulation flow 27 that can be formed in a case in which the drive frequency of the second energy generating element 24 is set to about 10 to 20 kHz which is in the same level as that of the drive frequency (ejection frequency) of the first energy generating element 14 is several mm/s to 100 mm/s.

In a case in which an ink having a high pigment concentration is used, increase in viscosity of the ink progresses in the ejection port 11 in accordance with a non-ejection time (pause time), and the ejection speed changes, and the ejection stability is likely to decrease. For example, an ink having such a concentration that the viscosity at the head operating temperature is at least 3 centipoise (cP) and not more than 6 cP can be said to be an ink having a high pigment concentration. In a case in which such an ink is used, ink circulation can be performed while the pause time is short. For this reason, concentration can be eliminated by performing steady ink circulation or high-frequency transient ink circulation. In the liquid ejection head 1 according to Example 1, by driving the second energy generating element 24, transient ink circulation can be caused to occur in the individual flow passage 23. For this reason, in the liquid ejection head 1 according to Example 1, by performing the circulation operation at a high frequency, the concentration in the ejection port 11 in a case in which a high-concentration ink is used can be eliminated.

In a case in which an ink having a low pigment concentration is used, although a change in the ejection speed may occur in accordance with a non-ejection time (pause time), the influence thereof is small relative to a high-concentration ink. For example, an ink having such a concentration that the viscosity at the head operating temperature is 1 cP or more and less than 3 cP can be said to be an ink having a low pigment concentration. When the suspension time is long, for example, the viscosity of the ink increases in the ejection port 11, for example, in accordance with a non-printing drive time (pause time). When restarting after stopping without printing for a predetermined time, by performing a suction operation, a wiping operation, and a recovery operation such as preliminary ejection in combination therewith, the influence of the thickened ink can be suppressed, however, such recovery operations involve waste ink.

In the liquid ejection head 1 according to Example 1, by forming the circulation flow 27 in the individual flow passage 23 by driving the second energy generating element 24, the concentration in the ejection port 11 is eliminated, and the increase in the viscosity ink can be suppressed. For this reason, depending on the stop time, it is also possible to prevent waste ink from being generated by performing recovery processing of only a circulation operation. In addition, recovery processing with reduced waste ink can be performed by combining a suction operation or the like for removing air bubbles inside of the head other than the elimination of concentration while recovering by performing a circulation operation.

In order to suppress the influence of a concentrated ink without depending on the concentration of the ink, an initial fresh ink can be supplied to the vicinity of the ejection port 11. In a case in which a circulation heater is used as the second energy generating element 24, the lower the influence of the re-circulation concentration, the better the effect of the circulation of ink can be acquired. Compared to the U-shaped ink circulation configuration, in the straight-type ink circulation configuration, the effect of maintaining the ejection performance according to ink circulation is exhibited more.

### Drive Control

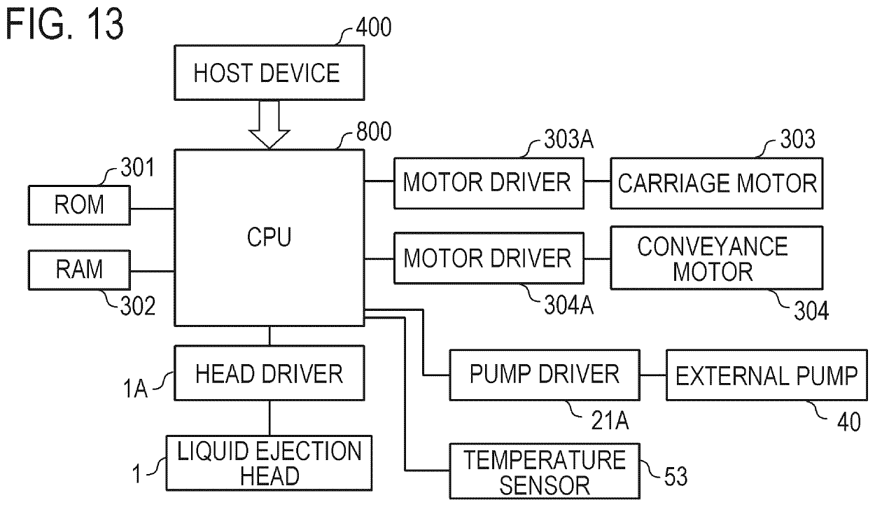

FIG. 13 is a block diagram illustrating a control configuration of the liquid ejection apparatus 50 according to Example 1. A central processing unit (CPU) 800 is a control portion for controlling the operation of the parts of the liquid ejection apparatus 50, on the basis of a program such as a processing procedure stored in a read only memory (ROM) 301. A random access memory (RAM) 302 is used as a working area or the like, when the CPU 800 executes processing. The CPU 800 receives image data from a host device 400 disposed outside of the liquid ejection apparatus 50, and controls the liquid ejection head 1 by controlling a head driver 1A on the basis of the image data. The CPU 800 receives information on the detected temperature from the temperature sensor 53. The CPU 800 controls the drive of the first energy generating element 14 and the second energy generating element 24 of the liquid ejection head 1 using the head driver 1A. In particular, the CPU 800 is a control portion for controlling the drive of the second energy generating element 24 on the basis of the temperature detected by the temperature sensor 53.

The CPU 800 also controls drivers of various types of actuators provided in the liquid ejection apparatus 50. For example, the CPU 800 controls a motor driver 303A of a carriage motor 303 for moving the carriage 60, a motor driver 304A of a conveying motor 304 for conveying the recording medium P, and a pump driver 21A of the external pump 40. Although FIG. 13 illustrates a configuration in which the image data is received from the host device 400, it is also possible to execute processing on the liquid ejection apparatus 50 without using any data from the host device 400.

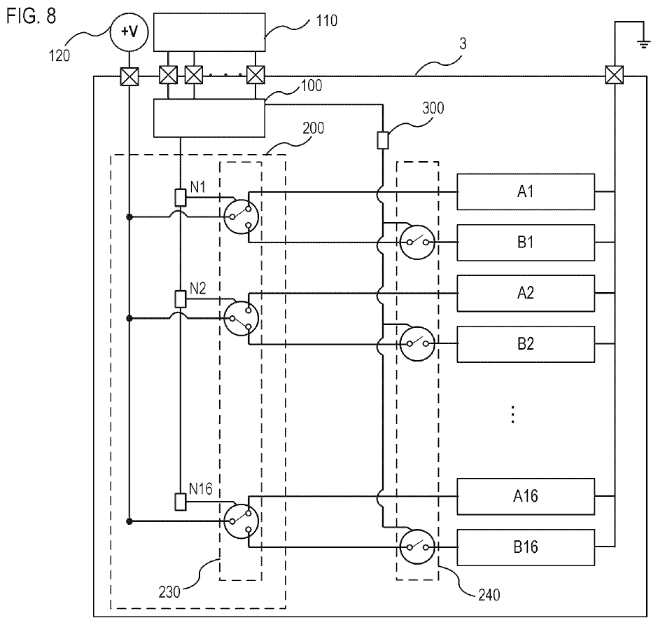

FIG. 8 is a diagram illustrating the control configuration of the liquid ejection head 1 according to Example 1. A substrate 18 of the liquid ejection chip 3 is provided with a controller 100, a selective drive circuit 200, an on/off drive circuit 240, a first energy generating element 14 (An) (n=1 to 16), and a second energy generating element 24 (Bn) (n=1 to 16). The liquid ejection chip 3 is connected to an external power source 120 and an external circuit 110. The external circuit 110 includes the head driver 1A illustrated in FIG. 13. A CPU 800 controlling the head driver 1A is a control unit (control portion) controlling the drive of the first energy generating element 14 and the second energy generating element 24.

The selective drive circuit 200 includes an on/on drive circuit 230 that selects the first energy generating element 14 and the second energy generating element 24. The on/on drive circuit 230 turns on any one of the first energy generating element 14 and the second energy generating element 24 to be driven in response to a control signal at each address Nn (n=1 to 16) received from the controller 100. The controller 100 controls a drive pulse used for driving the first energy generating element 14 or the second energy generating element 24 and a time interval for applying the drive pulse to each element.

The controller 100 controls the on/off drive circuit 240 using a drive enable/disable signal 300 of the second energy generating element 24. In accordance with this, the drive of the second energy generating element 24 in a case in which the second energy generating element 24 is selected in the on/on drive circuit 230 is controlled.

In this way, the drive of the second energy generating element 24 is controlled using the on/on drive circuit 230 and the on/off drive circuit 240.

In a case in which the drive enable/disable signal 300 is a signal for not driving the second energy generating element 24, even when the second energy generating element 24 is selected in the on/on drive circuit 230, the second energy generating element 24 is not driven. In this case, neither the first energy generating element 14 nor the second energy generating element 24 is driven. On the other hand, in a case where the first energy generating element 14 is selected in the on/on drive circuit 230, the first energy generating element 14 is driven.

In a case in which the drive enable/disable signal 300 is a signal for driving the second energy generating element 24, when the second energy generating element 24 is selected in the on/on drive circuit 230, the second energy generating element 24 is driven. When the first energy generating element 14 is selected, the first energy generating element 14 is driven.

Thus, the second energy generating element 24 is controlled in accordance with the drive data of the first energy generating element 14 and the drive enable/disable signal 300. In accordance with this, since drive data for the second energy generating element 24 does not need to be prepared, the amount of drive data can be reduced by half.

In the example illustrated in FIG. 8, although a configuration in which 16 sets of first energy generating elements 14 and second energy generating elements 24 (32 elements in total) are controlled as one group is illustrated, the configuration is not limited thereto. For example, 8 sets (16 elements), 12 sets (24 elements) of first energy generating elements 14 and second energy generating elements 24 may be controlled as one group. In addition, also in a case in which there are a plurality of second energy generating elements 24, the common drive enable/disable signal 300 can be used.

### Features of Example 1

FIGS. 9A and 9B are schematic diagrams illustrating in detail the vicinity of the ejection port of the liquid ejection head that ejects liquid such as ink in Example 1. FIG. 9A is a plan view seen in a direction in which liquid droplets are ejected from the ejection port 11. FIG. 9B is a cross-sectional view taken along the direction of arrow A illustrated in FIG. 9A.

First, the layout configuration of each part of the liquid ejection head 1 according to this example is described. Here, although a first direction, a second direction, and a third direction used for defining the layout of each part of the liquid ejection head 1 are the Z direction, the X direction, and the Y direction in this example, and the three directions are configured to be orthogonal to each other, the configuration is not limited to such a configuration. In a range not affecting the function and the like of the liquid ejection head 1, for example, the directions may be configured to have slight angles with respect to the Z direction, the X direction, and the Y direction and to intersect with each other.

As a configuration forming the ink ejection portion (liquid ejection portion), the liquid ejection head 1 according to this example has a pressure chamber 12, an ejection port 11, and a first energy generating element 14 generating energy for ejecting ink disposed inside of the pressure chamber from the ejection port 11. Such an ink ejection portion is arranged in the individual flow passage 23 (a circulation flow passage) extending in a second direction (the X direction) intersecting with a first direction (the Z direction) in which the ejection port 11 is opened. When the circulation flow of ink according to the second energy generating element 24 is formed, the individual flow passage 23 has an inlet 37 into which ink supplied to the pressure chamber 12 flows at one end in the second direction and an outlet 38 from which ink collected from the pressure chamber 12 flows out at the other end. On the outside of the inlet 37 of the individual flow passage 23, a first flow passage 61 (an inflow-side common flow passage) communicating with the individual flow passage 23 through the inlet 37 is disposed. In addition, on the outside of the outlet 38 of the individual flow passage 23, a second flow passage 62 (an outflow-side common flow passage) communicating with the individual flow passage 23 through the outlet 38 is disposed.

The first flow passage 61 and the second flow passage 62 are configured to communicate with each other through the common flow passage 29 (and the individual flow passage 23). The common flow passage 29 (a communication passage) has a first opening 22 (an inflow-side opening) opening in a first direction (the −Z direction) in the first flow passage 61 and an inflow-side common flow passage 72 (an inflow-side communication passage) extending in the first direction (the Z direction) from the first opening 22. In addition, the common flow passage 29 has a second opening 32 (an outflow-side opening) opening in the first direction (the −Z direction) in the second flow passage 62 and an outflow-side common flow passage 71 (an outflow-side communication passage) extending from the second opening 32 in the first direction (the Z direction). The outflow-side common flow passage 71 is formed on an inclined side surface 711 inclined such that the farther from the second opening 32 in the first direction (the Z direction), the larger the width in the second direction (the X direction). The inclined side surface 711 is inclined so as to spread beyond a position at which the inflow-side common flow passage 72 is disposed in the second direction. The inflow-side common flow passage 72 is a flow passage extending linearly along the first direction, is opened on the inclined side surface 711, and communicates with the outflow-side common flow passage 71.

A plurality of ink ejection portions each composed of the pressure chamber 12, the ejection port 11, and the first energy generating element 14 are disposed to be aligned in a third direction (the Y direction) intersecting with both the first direction (the Z direction) and the second direction (the X direction). The individual flow passage 23 is disposed in each of the plurality of ink ejection portions, and a plurality thereof are disposed in correspondence with the plurality of ink ejection portions. The first flow passage 61 (an inflow-side common flow passage) is configured as an inflow-side common flow passage communicating with the inlets 37 of the plurality of individual flow passages 23. The second flow passage 62 (an outflow-side common flow passage) is configured as an outflow-side common flow passage communicating with the outlets 38 of the plurality of individual flow passages 23.

A plurality of first openings 22 (inflow-side openings) of the common flow passage 29 opening to the first flow passage 61 are disposed to be aligned in the third direction (the Y direction), and the number thereof is smaller than the number of ink ejection portions (inlets 37). In other words, one of the plurality of first openings 22 functions as a common opening for some of the plurality of inlets 37.

The second opening 32 (the outflow-side opening) of the common flow passage 29 opening to the second flow passage 62 is a single opening that communicates with each of the plurality of outlets 38. The second opening 32 is also aligned in the second direction (the X direction) with respect to each of the plurality of outlets 38 and has an opening shape extending in the third direction (the Y direction) such that distances to each of the plurality of outlets 38 in the second direction are constant.

Next, features of the liquid ejection head 1 according to this example are described. The liquid ejection head 1 according to this example includes a first opening 22 and a second opening 32, and an ejection port 11, a first energy generating element 14, and a second energy generating element 24 (a circulation heat generating element) are arranged in a flow passage between the first opening 22 and the second opening 32. Here, the first energy generating element 14 is arranged close to the second opening 32, and the second energy generating element 24 (a circulation heat generating element) is arranged close to the first opening 22. In case of such an arrangement, as described above, since the circulation flow becomes a flow from the second energy generating element 24 (the circulation heat generating element) toward the first energy generating element 14, a flow for flowing out to the second opening 32 is generated.

In addition, a plurality of first openings 22 are disposed to form a supply opening row. The second opening 32 is formed as a common supply opening. In this example, the first energy generating elements 14 and the second energy generating elements 24 are respectively arranged at a pitch of 600 dots per inch (dpi), and the second openings 32 are arranged at a pitch of 150 dpi.

As a feature of this example, the first energy generating element 14 is arranged close to the second opening 32 that is a common supply opening. In addition, as effects according to such a configuration, there are the following. That is, there are two points including (1) suppression of variations in ejection characteristics of ejection heat generating elements that are the first energy generating elements 14, and (2) suppression of concentration of inflowing ink in accompaniment with the ejection from the second opening 32.

Hereinafter, details are described. Ink may be supplied to the inside of the ejection port 11 in accompaniment with the ejection of the first energy generating element 14. For the supply of ink, the ink flows from the second opening 32 through the individual flow passage 23. In a case in which a distance from each individual flow passage 23 to the second opening 32 is different for each nozzle, ejection characteristics are different for each nozzle, and the refill characteristics of a nozzle remote from the second opening 32 are degraded. For this reason, the second opening 32 close to the ejection heat generating element, which is the first energy generating element 14, may be formed as a common supply opening. On the other hand, although the first opening 22 is divided into individual supply openings, the circulation heat generating element, which is the second energy generating element 24, only generates a circulation flow rate, and thus the influence on the ejection is small. For this reason, the first opening 22 has a small influence also in the individual supply opening. Accordingly, by arranging the first energy generating element 14 close to the second opening 32, which is a common supply opening, the degradation of the ejection characteristics of the ejection heat generating element can be suppressed.

Further, by driving a circulation heat generating element that is the second energy generating element 24, a circulation flow is generated to eliminate the concentrated ink inside of the ejection port 11. The concentrated ink flows out to the outflow-side common flow passage 71 through the common second opening 32 on the downstream side. Here, the outflow-side common flow passage 71 is configured to have an inclined shape and has an extremely large opening volume. For this reason, it becomes possible to dilute the concentrated ink that has been flown out. For this reason, even when ink flows in from the second opening 32 in accordance with refill of the ink accompanying the ejection of the ejection heat generating element, the concentrated ink is diluted, and thus the influence of the concentration is suppressed.

Although the inclined shape of the outflow-side common flow passage 71 may be various shapes in accordance with an etching method for the substrate 18, effects similar to those of this example can be acquired for any shape. The configuration illustrated in FIG. 9B is a configuration example in which the outflow-side common flow passage 71 is formed by Si processing using anisotropic etching, and the inflow-side common flow passage 72 is formed by processing using a dry etching process. As details of the manufacturing method (molding method) of the substrate 18, a method similar to the manufacturing method described in Example 2 to be described below can be used.

Further, as an advantage of configuring the first opening 22 as a plurality of openings, a part of the substrate 18 to which the first opening 22 is not opened has a beam structure and can be used as a portion through which a wiring passes. In other words, the wiring layout for driving the ejection heat generating element, which is the first energy generating element 14, and the circulation heat generating element, which is the second energy generating element 24, can be easily performed.

### Example 2

Example 2 of the present disclosure is described with reference to FIGS. 10A and 10B to FIGS. 12A to 12H. Here, in Example 2, the same reference signs are assigned to configurations that are common to Example 1, and mainly differences of Example 2 from Example 1 are described. In Example 2, matters not specifically described here are similar to those according to Example 1.

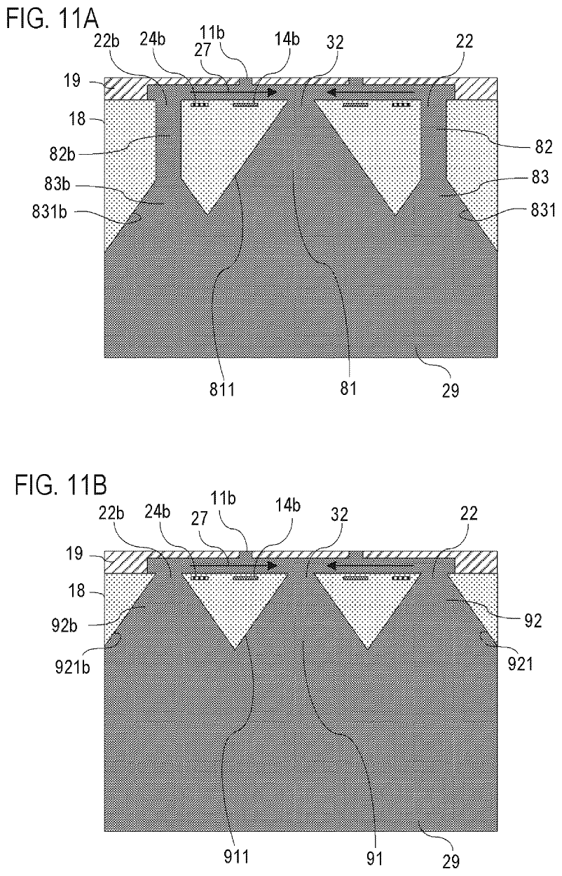

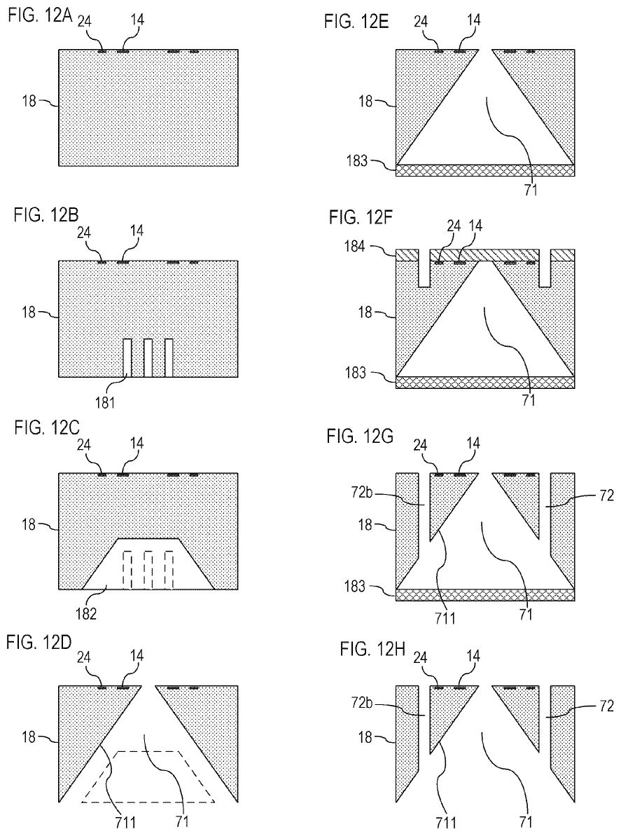

FIGS. 10A and 10B are schematic diagrams illustrating the vicinity of an ejection port of a liquid ejection head according to Example 2 in detail. FIG. 10A is a plan view seen in a direction in which liquid droplets are ejected from the ejection port 11. FIG. 10B is a cross-sectional view taken along the direction of arrow B illustrated in FIG. 10A. FIG. 11A is a cross-sectional view of a liquid ejection head according to Modification 1 of Example 2 and is a cross-sectional view corresponding to a cross-sectional view taken along the direction of arrow B illustrated in FIG. 10A. FIG. 11B is a cross-sectional view of a liquid ejection head according to Modification 2 of Example 2 and is a cross-sectional view corresponding to a cross-sectional view taken along the direction of arrow B illustrated in FIG. 10A. FIGS. 12A to 12H are process explanatory diagrams of the process of a manufacturing method for a liquid ejection head according to Example 2.

First, the layout configuration of each part of the liquid ejection head according to this example is described. The liquid ejection head according to this example has a configuration in which a mirror-symmetric configuration having opposite orientation in the second direction is additionally arranged on a side opposite to a second opening 32 to the configuration composed of the ink ejection portion, the individual flow passage 23, the first flow passage 61, and the inflow-side common flow passage 72 according to Example 1.

More specifically, in the second opening 32 (the outflow-side opening) in the second direction (the X direction), a second ink ejection portion is provided on a side opposite to a side on which a plurality of ink ejection portions (an ejection portion 11, a pressure chamber 12, and a first energy generating element 14) are aligned. The second ink ejection portion (the second liquid ejection portion) is composed of an ejection port 11b, a pressure chamber 12b, and a first energy generating element 14b, and a plurality of second ink ejection portions is aligned in a third direction (the Y direction). A plurality of individual flow passages 23b (second circulation flow passages) are provided in correspondence with the plurality of second ink ejection portions. The individual flow passage 23b has an inlet 37b (a second inlet) positioned on the other side of the pressure chamber 12b in the second direction (X direction) and an outlet 38b (a second outlet) positioned on one side of the pressure chamber 12b in the second direction. The individual flow passage 23b extends in the second direction such that the outlet 38b, the pressure chamber 12b, and the inlet 37b are aligned in this order in the second direction (a direction (−X direction) from one side in the second direction toward the other side). A third flow passage 61b (a second inflow-side common flow passage) is formed outside of the inlet 37b. The common flow passage 29 according to this example has an inflow-side common flow passage 72b (a second inflow-side communication passage) configured to have mirror symmetry of the inflow-side common flow passage 72 with respect to the second opening 32. The inflow-side common flow passage 72b has a third opening 22b (a second inflow-side opening) opening to the third flow passage 61b in the first direction (Z direction), extends from the third opening 22b in the first direction, is opened to an inclined side surface 711 of the outflow-side common flow passage 71, and communicates with the outflow-side common flow passage 71.

Next, features of the liquid ejection head according to this example are described. The liquid ejection head according to this example includes a first opening 22, a second opening 32, and a third opening 22b. A second energy generating element 24 (a circulation heat generating element), an ejection port 11, and a first energy generating element 14 are arranged in a flow passage between the first opening 22 and the second opening 32. Similarly, a second energy generating element 24b (a circulation heat generating element), an ejection port 11b, and a first energy generating element 14b are arranged in a flow passage between the second opening 32 and the third opening 22b. Here, both the first energy generating elements 14 and 14b are arranged close to the second opening 32, and the second energy generating elements 24 and 24b (circulation heat generating elements) are arranged close to supply ports of the first opening 22 and the third opening 22b. In case of such an arrangement, as described above, since the circulation flow becomes a flow from the second energy generating elements 24 and 24b (the circulation heat generating elements) toward the first energy generating elements 14 and 14b, a flow for flowing out to the second opening 32 is generated.

In addition, a plurality of the first and third openings 22 and 22b is respectively disposed to form supply opening rows. The second opening 32 is formed as a common supply opening. The first openings 22 and the third openings 22b are respectively arranged at a pitch of 300 dpi. In this example, the row of the ejection ports 11b has an arrangement configuration in which the position deviates from the row of the ejection ports 11 in the third direction. In addition, although two rows of the supply opening rows are located at the same position in an inter-ejection port row direction, they may deviate to match the position of the ejection port in each row.

As a feature of this example, the first energy generating element 14 is arranged close to the second opening 32 that is a common supply opening. As effects according to such a configuration, there are the following. That is, there are two points including (1) suppression of variations in ejection characteristics of ejection heat generating elements that are the first energy generating elements 14, and (2) suppression of concentration of inflowing ink in accompaniment with the ejection from the second opening 32.

Hereinafter, details are described. Ink may be supplied to the inside of the ejection port 11 in accompaniment with the ejection of the first energy generating element 14. For the supply of ink, the ink flows from the second opening 32 through the individual flow passage 23. In a case in which a distance from each individual flow passage 23 to the second opening 32 is different for each nozzle, ejection characteristics are different for each nozzle, and the refill characteristics of a nozzle remote from the second opening 32 are degraded. For this reason, the second opening 32 close to the ejection heat generating element, which is the first energy generating element 14, may be formed as a common supply opening. On the other hand, although the first opening 22 and the third supply opening 42 are divided into individual supply openings, the circulation heat generating element, which is the second energy generating element 24, only generates a circulation flow rate, and thus the influence on the ejection is small. For this reason, the first opening 22 and the third supply opening 42 have a small influence also in the individual supply openings. Accordingly, by arranging the first energy generating element 14 close to the second opening 32, which is a common supply opening, the degradation of the ejection characteristics of the ejection heat generating element can be suppressed.

Further, by driving a circulation heat generating element that is the second energy generating element 24, a circulation flow is generated to eliminate the concentrated ink inside of the ejection port 11. The concentrated ink flows out to the outflow-side common flow passage 71 through the common second opening 32 on the downstream side. Here, the outflow-side common flow passage 71 is configured to have an inclined shape and has an extremely large opening volume. For this reason, it becomes possible to dilute the concentrated ink that has been flown out. For this reason, even when ink flows in from the second opening 32 in accordance with refill of the ink accompanying the ejection of the ejection heat generating element, the concentrated ink is diluted, and thus the influence of the concentration is suppressed.

Although the inclined shape of the outflow-side common flow passage 71 may be various shapes in accordance with an etching method for the substrate 18, effects similar to those of this example can be acquired for any shape. The configuration illustrated in FIG. 10B is a configuration example in which the outflow-side common flow passage 71 is formed by Si processing using anisotropic etching, and the inflow-side common flow passages 72 and 72b are formed to individually communicate with the outflow-side common flow passage 71, which has been formed using the anisotropic etching through processing using dry etching. For example, in a case in which a Si wafer of type ( #100) is anisotropically etched, the inflow-side common passages are patterned and processed at an angle of 54.7 degrees with respect to a crystal axis direction.

FIG. 11A illustrates Modification 1 of Example 2. In a liquid ejection head of Modification 1, the common flow passage 29 has an inflow-side downstream common flow passage 82, an inflow-side upstream common flow passage 83, an outflow-side common flow passage 81, an inflow-side downstream common flow passage 82b, and an inflow-side upstream common flow passage 83b. The inflow-side downstream common flow passage 82 has a first opening 22 and linearly extends to the inflow-side upstream common flow passage 83 in the first direction. The inflow-side upstream common flow passage 83 is formed on an inclined side surface 831 inclined such that the father from the inflow-side downstream common flow passage 82 in the first direction (the Z direction), the larger the width in the second direction (the X direction). The outflow-side common flow passage 81 has a second opening 32 and is formed on an inclined side surface 811 inclined such that the father from the second opening 32 in the first direction (the Z direction), the larger the width in the second direction (the X direction). The inflow-side downstream common flow passage 82b has a third opening 22b and linearly extends to the inflow-side upstream common flow passage 83b in the first direction. The inflow-side upstream common flow passage 83b is formed on an inclined side surface 831b inclined such that the farther from the inflow-side downstream common flow passage 82b in the first direction (the Z direction), the larger the width in the second direction (the X direction). The inflow-side upstream common flow passage 83, the outflow-side common flow passage 81, and the inflow-side upstream common flow passage 83b are formed by Si processing using anisotropic etching. The inflow-side downstream common flow passage 82 and the inflow-side downstream common flow passage 82b are formed by performing dry-etching processing on the inflow-side upstream common flow passage 83 and the inflow-side upstream common flow passage 83b formed through the anisotropic etching to communicate with each other.

FIG. 11B illustrates Modification 2 of Example 2. In a liquid ejection head according to Modification 2, the common flow passage 29 has an inflow-side common flow passage 92, an outflow-side common flow passage 91, and an inflow-side common flow passage 92b. The inflow-side common flow passage 92 has a first opening 22 and is formed on an inclined side surface 921 inclined such that the farther from the first opening 22 in the first direction (the Z direction), the larger the width in the second direction (the X direction). The outflow-side common flow passage 91 has a second opening 32 and is formed on an inclined side surface 911 inclined such that the farther from the second opening 32 in the first direction (the Z direction), the larger the width in the second direction (the X direction). The inflow-side common flow passage 92b has a third opening 22b and is formed on an inclined side surface 921b inclined such that the farther from the third opening 22b in the first direction (the Z direction), the larger the width in the second direction (the X direction). All the inflow-side common flow passage 92, the outflow-side common flow passage 91, and the inflow-side common flow passage 92b are formed by Si processing using anisotropic etching.

FIGS. 12A to 12H are cross-sectional views illustrating process diagrams of the process of manufacturing the liquid ejection head according to Example 2 illustrated in FIG. 10B. FIG. 12A illustrates the initial state of the substrate 18 of the liquid ejection head (a state in which the common flow passage 29 composed of the outflow-side common flow passage 71 and the inflow-side common flow passages 72 and 72b is not formed). FIG. 12B illustrates a state in which a plurality of holes 181 is formed on the rear surface side of the substrate 18 (the surface side opposite to the surface on which the first energy generating element 14 and the second energy generating element 24 are formed) by performing a plurality of times of laser processing. FIG. 12C illustrates a state in which anisotropic etching is progressed with the plurality of holes 181 as starting points by immersing the substrate 18 after laser processing in an etching solution, and recesses 182 are formed. FIG. 12D illustrates a state in which the recesses 182 are processed so as to communicate with the front surface side of the substrate 18 (the surface side on which the first energy generating element 14 and the second energy generating element 24 are formed). FIG. 12E illustrates a state in which a film 183 is attached to the rear surface side of the substrate 18. FIG. 12F illustrates a state in which a dry-etching surface resist patterning 184 is formed on the surface side of the substrate 18, and an etching process is progressed. FIG. 12G illustrates a state in which the holes that have been opened through the dry etching illustrated in FIG. 12F are caused to communicate with the outflow-side common flow passage 71 that have been opened in advance and are formed as the inflow-side common flow passages 72 and 72b. Thereafter, FIG. 12H illustrates a state in which the film 183 on the rear surface side of the substrate 18 is peeled off, and the process is completed.

In each of the above examples, the respective configurations can be combined.

According to the present disclosure, ejection characteristics and circulation characteristics of a liquid can be improved in a liquid ejection head including a liquid, an energy generating element for ejection, and an energy generating element for causing the liquid to flow.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of priority from Japanese Patent Application No. 2024-156848, filed on Sep. 10, 2024, which is hereby incorporated by reference herein in its entirety.

What is claimed is:

1. A liquid ejection head comprising:
a liquid ejection portion configured to have a pressure chamber, an ejection port used for ejecting liquid from the pressure chamber, and a first energy generating element generating energy for ejecting the liquid disposed inside of the pressure chamber from the ejection port;
a circulation flow passage configured to have an inlet in which the liquid supplied to the pressure chamber flows and an outlet from which the liquid collected from the pressure chamber flows out, the circulation flow passage having the pressure chamber arranged between the inlet and the outlet;
a second energy generating element configured to be disposed on a side closer to the inlet than the first energy generating element in the circulation flow passage; and
a common flow passage configured to include an outflow-side common flow passage, an inflow-side common flow passage, and a communication passage, the outflow-side common flow passage being formed outside of the outlet, the inflow-side common flow passage being formed outside of the inlet, and the communication passage allowing the outflow-side common flow passage and the inflow-side common flow passage to communicate with each other,
wherein the ejection port is opened in a first direction,
wherein the inlet is positioned on one side of the pressure chamber in a second direction intersecting with the first direction,
wherein the outlet is positioned on the other side of the pressure chamber in the second direction,
wherein the circulation flow passage extends in the second direction such that the inlet, the pressure chamber, and the outlet are aligned in this order in the second direction, and
wherein the communication passage has an outflow-side opening that is opened in the first direction in the outflow-side common flow passage and includes an outflow-side communication passage, and the outflow-side communication passage is formed on a side surface inclined such that the farther from the outflow-side opening in the first direction, the larger a width in the second direction.

2. The liquid ejection head according to claim 1,
wherein the communication passage has an inflow-side opening that is opened in the first direction in the inflow-side common flow passage and includes an inflow-side communication passage, and the inflow-side communication passage extends from the inflow-side opening in the first direction, is opened on the side surface of the outflow-side communication passage, and communicates with the outflow-side communication passage.

3. The liquid ejection head according to claim 2,
wherein the inflow-side communication passage linearly extends in the first direction.

4. The liquid ejection head according to claim 2,
wherein the inflow-side communication passage is formed on a side surface that is inclined such that the farther from the inflow-side opening in the first direction, the larger a width in the second direction.

5. The liquid ejection head according to claim 2,
wherein a plurality of the liquid ejection portions is disposed to be aligned in a third direction intersecting with both the first direction and the second direction,
wherein a plurality of the circulation flow passages is disposed in correspondence with the plurality of the liquid ejection portions,
wherein the outflow-side common flow passage communicates with each of the outlets of the plurality of the circulation flow passages,
wherein the inflow-side common flow passage communicates with each of the inlets of the plurality of the circulation flow passages, and
wherein the outflow-side opening is a single opening that communicates with each of the plurality of the outlets, and the outflow-side opening is also aligned with each of the plurality of outlets in the second direction and has a shape extending in the third direction such that distances to each of the plurality of the outlets in the second direction are constant.

6. The liquid ejection head according to claim 5,
wherein a plurality of the inflow-side openings is disposed to be aligned in the third direction, and the number of the plurality of the inflow-side openings is smaller than the number of the plurality of the liquid ejection portions.

7. The liquid ejection head according to claim 5,
wherein the liquid ejection portion is a first liquid ejection portion, the circulation flow passage is a first circulation flow passage, the inlet is a first inlet, the outlet is a first outlet, the inflow-side common flow passage is a first inflow-side common flow passage, the inflow-side opening is a first inflow-side opening, and the inflow-side communication flow passage is a first inflow-side communication passage,
the liquid ejection head further comprising:
a plurality of second liquid ejection portions aligned in the third direction on a side opposite to a side on which the plurality of the first liquid ejection portions is arranged in the outflow-side opening in the second direction; and
a plurality of second circulation flow passages disposed in correspondence with the plurality of the second liquid ejection portions, the second circulation flow passage having a second inlet positioned on the other side of the pressure chamber of the second liquid ejection portion in the second direction and a second outlet positioned on one side of the pressure chamber of the second liquid ejection portion in the second direction, and the second circulation flow passage extending in the second direction such that the second outlet, the pressure chamber of the second liquid ejection portion, and the second inlet are aligned in this order in the second direction,
wherein the communication passage includes:
a second inflow-side common flow passage formed outside of the second inlet; and
a second inflow-side communication passage having a second inflow-side opening that is opened in the first direction in the second inflow-side common flow passage, the second inflow-side communication passage extending from the second inflow-side opening in the first direction, being opened on the side surface of the outflow-side communication passage, and communicating with the outflow-side communication passage.

8. The liquid ejection head according to claim 7,
wherein the second inflow-side communication passage linearly extends in the first direction.

9. The liquid ejection head according to claim 7,
wherein the second inflow-side communication passage is formed on a side surface that is inclined such that the farther from the inflow-side opening in the first direction, the larger a width in the second direction.

10. The liquid ejection head according to claim 7,
wherein a plurality of the second inflow-side openings is disposed to be aligned in the third direction, and the number of the plurality of the second inflow-side openings is smaller than the number of the plurality of the second liquid ejection portions.

11. The liquid ejection head according to claim 1,
wherein a flow resistance ratio R1/R2 of a flow resistance R1 between the second energy generating element and the inlet to a flow resistance R2 between the second energy generating element and the outlet in the circulation flow passage is at least 0.05 and not more and 0.40.

12. The liquid ejection head according to claim 11,
wherein the second energy generating element is an electro-thermal conversion element.

13. The liquid ejection head according to claim 5,
wherein a plurality of the second energy generating elements corresponding to the plurality of the liquid ejection portions is configured to be driven using a common control signal.

14. A liquid ejection apparatus comprising:
the liquid ejection head according to claim 1; and
a supply unit configured to supply a liquid to the liquid ejection head.

15. A manufacturing method for manufacturing the liquid ejection head according to claim 1, the method comprising:
forming the outflow-side communication passage using anisotropic etching.

16. A manufacturing method for manufacturing the liquid ejection head according to claim 3, the method comprising:
forming the outflow-side communication passage using anisotropic etching, and
forming the inflow-side communication passage using dry etching.

17. A manufacturing method for manufacturing the liquid ejection head according to claim 4, the method comprising:
forming the outflow-side communication passage and the inflow-side communication passage using anisotropic etching.

18. A manufacturing method for manufacturing the liquid ejection head according to claim 8, the method comprising:
forming the second inflow-side communication passage using dry etching.

19. A manufacturing method for manufacturing the liquid ejection head according to claim 9, the method comprising:
forming the second inflow-side communication passage using anisotropic etching.
